(19) United States
(12) Patent Application Publication
(10) Pub. No.: US 2015/0006310 A1
(43) Pub. Date: Jan. 1, 2015

(54) VARIABLE THRESHOLDS FOR MULTIPLE POSITION CONTENT AUCTIONS

(71) Applicant: Google Inc., Mountain View, CA (US)

(72) Inventors: Anand Murugappan, Mountain View, CA (US); Gregory Jay Friedman, Mountain View, CA (US)

(21) Appl. No.: 13/927,541

(22) Filed: Jun. 26, 2013

(51) Int. Cl. G06Q 30/08

(52) U.S. Cl. CPC G06Q 30/08
USPC 705/26.3

(57) ABSTRACT

Systems, methods, and computer-readable storage media that may be used to populate a content interface having several positions are provided. One method includes determining a first set of eligible content bids by comparing a performance characteristic of each content bid with a first threshold value. The method further includes conducting a first auction process on the first set of one or more eligible content bids to determine one or more first content items to be displayed in at least one position of a content interface. The method further includes determining a second set of eligible content bids by comparing a performance characteristic of each content bid with a second threshold value. The method further includes conducting a second auction process on the second set of one or more eligible content bids to determine content items to be displayed in at least one other position of the content interface.

### BACKGROUND

Content items displayed within content interfaces of a resource, such as a webpage or other application interface, may be selected using an auction process. An auction system may determine two or more bids for content to be displayed in a content interface that are likely to be contextually relevant to a user and run the bids through an auction process to determine one or more winning bids to be displayed in the content interface. In some implementations, the auction system may restrict some bids from being included in the auction based on certain factors that may, for example, be intended to increase the likelihood that the winning content items will be of interest to the user viewing the resource. Under some circumstances, these factors may cause less than a maximum amount of items to be displayed within the content interface. For example, if a content interface has eight positions in which content items may be displayed, and only five bids satisfy the enforced eligibility factors, three positions within the interface may remain empty when presented to the user.

### SUMMARY

One implementation of the disclosure relates to a method including calculating, for each of a plurality of content bids, one or more performance characteristics associated with the content bid. The method further includes determining, using a computerized auction system, a first set of one or more eligible content bids from among a plurality of content bids by comparing the one or more performance characteristics of each content bid with a first set of one or more eligibility criteria. The first set of one or more eligibility criteria includes at least one first threshold value, and each of the plurality of content bids includes a bid value and a content item associated with the content bid. The first threshold value represents a first minimum performance measure for content items to be displayed within one or more first positions of a content interface, and the content interface comprises a plurality of positions in which content items can be displayed. The method further includes conducting, using the auction system, a first auction process on the first set of one or more eligible content bids to determine one or more first content items to be displayed in the one or more first positions of the content interface. The method further includes determining, using the auction system, a second set of one or more eligible content bids from among the plurality of content bids by comparing the one or more performance characteristics of each content bid with a second set of one or more eligibility criteria. The second set of one or more eligibility criteria includes at least one second threshold value that is different from the at least one first threshold value. The second threshold value represents a second minimum performance measure for content items to be displayed within one or more second positions of the content interface. The method further includes conducting, using the auction system, a second auction process on the second set of one or more eligible content bids to determine one or more second content items to be displayed in the one or more second positions of the content interface. The method further includes generating, using the auction system, the content interface including the determined one or more first content items to be displayed and one or more second content items to be displayed and transmitting, using the auction system, data representative of the generated content interface to a computing device of a user.

Another implementation of the disclosure relates to a system including at least one computing device operably coupled to at least one memory and configured to calculate, for each of a plurality of content bids, one or more performance characteristics associated with the content bid. The at least one computing device is further configured to determine a first set of one or more eligible content bids from among a plurality of content bids by comparing the one or more performance characteristics of each content bid with a first set of one or more eligibility criteria. The first set of one or more eligibility criteria includes at least one first threshold value, and each of the plurality of content bids includes a bid value and a content item associated with the content bid. The first threshold value represents a first minimum performance measure for content items to be displayed within one or more first positions of a content interface, and the content interface comprises a plurality of positions in which content items can be displayed. The at least one computing device is further configured to conduct a first auction process on the first set of one or more eligible content bids to determine one or more first content items to be displayed in one or more first positions of the content interface. The at least one computing device is further configured to determine a second set of one or more eligible content bids from among the plurality of content bids by comparing the one or more performance characteristics of each content bid with a second set of one or more eligibility criteria. The second set of one or more eligibility criteria includes at least one second threshold value that is different from the at least one first threshold value. The second threshold value represents a second minimum performance measure for content items to be displayed within one or more second positions of the content interface. The at least one computing device is further configured to conduct a second auction process on the second set of one or more eligible content bids to determine one or more second content items to be displayed in one or more second positions of the content interface. The at least one computing device is further configured to generate the content interface including the determined one or more first content items to be displayed and one or more second content items to be displayed and transmit data representative of the generated content interface to a computing device of a user.

Another implementation of the disclosure relates to a computer-readable storage medium having instructions stored thereon that, when executed by a processor, cause the processor to perform operations including calculating, for each of a plurality of content bids, one or more performance characteristics associated with the content bid. Each of the plurality of content bids includes a bid value and a content item associated with the content bid. The operations further include conducting a plurality of auction processes to determine content items to include within a content interface including a plurality of positions in which content items can be displayed. Conducting a plurality of auction processes includes conducting a separate auction process for each position of the plurality of positions of the content interface. Conducting a plurality of auction processes further includes, for each of the separate auction processes: (1) determining a set of one or more eligible content bids from among a plurality of content bids by comparing the one or more performance characteristics of each content bid with a set of one or more eligibility criteria for the auction process; and (2) conducting the auction process on the set of one or more eligible content bids to determine a winning content item to be displayed in the associated position of a content interface. The set of one or more eligibility criteria for each auction process includes at least one threshold value, the at least one threshold value includes a first minimum performance measure for content items to be displayed within the associated position of the content interface, and the at least one threshold value for one of the separate auction processes is different from the at least one threshold value for at least one other of the separate auction processes. The operations further include generating the content interface including the winning content item from each of the separate auction processes and transmitting data representative of the generated content interface to a computing device of a user.

Yet another implementation of the disclosure relates to a method that includes determining, for each of a plurality of content bids, a characteristic of a content campaign associated with the content bid. The method further includes conducting, using a computerized auction system, at least one first auction process to select a first set of one or more winning content bids from among the plurality of content bids based in part on a first eligibility constraint. Each of the plurality of content bids includes a bid to include a content item associated with the content campaign within a content interface. The content interface includes a plurality of positions in which content items can be displayed. The first eligibility constraint includes a limitation on the number of winning bids that share a particular characteristic. The method further includes determining, using the auction system, whether a number of winning content bids within the first set of one or more winning content bids selected using the at least one first auction process is less than a number of positions within the content interface. The method further includes, when the number of winning content bids within the first set of one or more winning content bids is less than a number of positions within the content interface, conducting, using the auction system, at least one second auction process to select a second set of one or more winning content bids by either disabling the first eligibility constraint or applying a second eligibility constraint to the plurality of content bids instead of the first eligibility constraint. The second eligibility constraint permits a larger number of winning content bids to share the particular characteristic than are permitted under the first eligibility constraint. The method further includes generating, using the auction system, the content interface based on at least one of the first set of one or more winning content bids or the second set of one or more winning content bids. The method further includes transmitting, using the auction system, data representative of the generated content interface to a computing device of a user. The operations of conducting at least one first auction process, determining whether a number of winning content bids within the first set of one or more winning content bids selected using the at least one first auction process is less than a number of positions within the content interface, conducting at least one second auction process, generating the content interface, and transmitting data representative of the generated content interface may all be performed in response to a single request to provide content items for the content interface.

Another implementation of the disclosure relates to a system including at least one computing device operably coupled to at least one memory and configured to determine, for each of a plurality of content bids, a characteristic of a content campaign associated with the content bid. The at least one computing device is further configured to conduct at least one first auction process to select a first set of one or more winning content bids from among the plurality of content bids based in part on a first eligibility constraint. Each of the plurality of content bids includes a bid to include a content item associated with the content campaign within a content interface. The content interface includes a plurality of positions in which content items can be displayed. The first eligibility constraint includes a limitation on the number of winning bids that share a particular characteristic. The at least one computing device is further configured to determine whether a number of winning content bids within the first set of one or more winning content bids selected using the at least one first auction process is less than a number of positions within the content interface. The at least one computing device is further configured to, when the number of winning content bids within the first set of one or more winning content bids is less than a number of positions within the content interface, conduct at least one second auction process to select a second set of one or more winning content bids by either disabling the first eligibility constraint or applying a second eligibility constraint to the plurality of content bids instead of the first eligibility constraint. The second eligibility constraint permits a larger number of winning content bids to share the particular characteristic than are permitted under the first eligibility constraint. The at least one computing device is further configured to generate the content interface based on at least one of the first set of one or more winning content bids or the second set of one or more winning content bids. The at least one computing device is further configured to transmit data representative of the generated content interface to a computing device of a user. The at least one computing device may be configured to conduct the at least one first auction process, determine whether the number of winning content bids within the first set of one or more winning content bids selected using the at least one first auction process is less than the number of positions within the content interface, conduct the at least one second auction process, generate the content interface, and transmit the data representative of the generated content interface all in response to a single request to provide content items for the content interface.

Another implementation of the disclosure relates to a computer-readable storage medium having instructions stored thereon that, when executed by a processor, cause the processor to perform operations including determining, for each of a plurality of content bids, one or more characteristics of a content campaign associated with the content bid. Each of the plurality of content bids includes a bid to include a content item within a content interface. The content interface includes a plurality of positions in which content items can be displayed. The operations further include conducting a plurality of auction processes to determine content items to include within the content interface. Conducting a plurality of auction processes includes conducting at least one separate auction process for each position of the plurality of positions of the content interface. Conducting a plurality of auction processes further includes, for each of the plurality of positions of the content interface: (1) conducting a first auction process to select a winning content bid for the position from among the plurality of content bids based in part on a first eligibility constraint; (2) determining whether the first auction process resulted in selecting a winning content bid for the position; and (3) when the first auction process is determined not to have resulted in selecting a winning content bid for the position, conducting a second auction process to select a winning bid for the position by either disabling the first eligibility constraint or applying a second eligibility constraint to the plurality of content bids instead of the first eligibility constraint. The first eligibility constraint comprises a limitation on the number of winning bids included within the content interface that share a particular characteristic. The second eligibility constraint permits a larger number of winning content bids to share the particular characteristic than are permitted under the first eligibility constraint. The operations further include generating the content interface including the content items of the winning content bids and transmitting data representative of the generated content interface to a computing device of a user. The operations of conducting a plurality of auction processes, generating the content interface, and transmitting data representative of the generated content interface may all be performed in response to a single request to provide content items for the content interface.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a display image of a search results screen including several content interfaces according to an illustrative implementation.

FIG. 2 is a block diagram of an auction system and associated environment according to an illustrative implementation.

FIG. 3 is a more detailed block diagram of an auction system and associated environment according to an illustrative implementation.

FIG. 4 is a flow diagram of a process for selecting content to include in a multiple-position content interface using different threshold eligibility values for different positions according to an illustrative implementation.

FIG. 5 is a flow diagram of a process for selecting content to include in a multiple-position content interface using different threshold eligibility values for different positions and using a separate auction for each position according to an illustrative implementation.

FIG. 6 is a graph comparing thresholds for different positions determined using two different methods according to an illustrative implementation.

FIG. 7A is a display image of a multiple-position content interface in which a single threshold value has been applied in selecting content items eligible for all of the positions according to an illustrative implementation.

FIG. 7B is a display image of a multiple-position content interface in which different threshold values have been applied to select content items eligible for different positions according to an illustrative implementation.

FIG. 8 is a flow diagram of a process for selecting content to include in a multiple-position content interface using diversity filters that vary across positions according to an illustrative implementation.

FIG. 9 is a flow diagram of a process for selecting content to include in a multiple-position content interface using diversity filters that vary across positions and using at least one separate auction process for each position according to an illustrative implementation.

FIG. 10A is a display image of a multiple-position content interface in which a single diversity filter has been applied in selecting content items eligible for all of the positions according to an illustrative implementation.

FIG. 10B is a display image of a multiple-position content interface in which different diversity filters have been applied to select content items eligible for different positions according to an illustrative implementation.

FIG. 11 is a state diagram illustrating different combinations of diversity filters that may be applied to determine different sets of eligible content bids according to an illustrative implementation.

FIG. 12 is a flow diagram of a process for selecting content to include in a multiple-position content interface using both varying threshold values and varying diversity filters according to an illustrative implementation.

FIG. 13 is a block diagram of a computing system according to an illustrative implementation.

### DETAILED DESCRIPTION

Referring generally to the Figures, various illustrative systems and methods are provided that may be used to increase the number of positions that are filled within a multiple-position content interface while still allowing content bids to be filtered based on certain eligibility criteria. Some content display interfaces within resources (e.g., webpages) have a specific number of available positions in which content items can be displayed. For example, a shopping content interface may have a maximum of five positions in which content items can be displayed, and the interface may be configured to display between three and five content items.

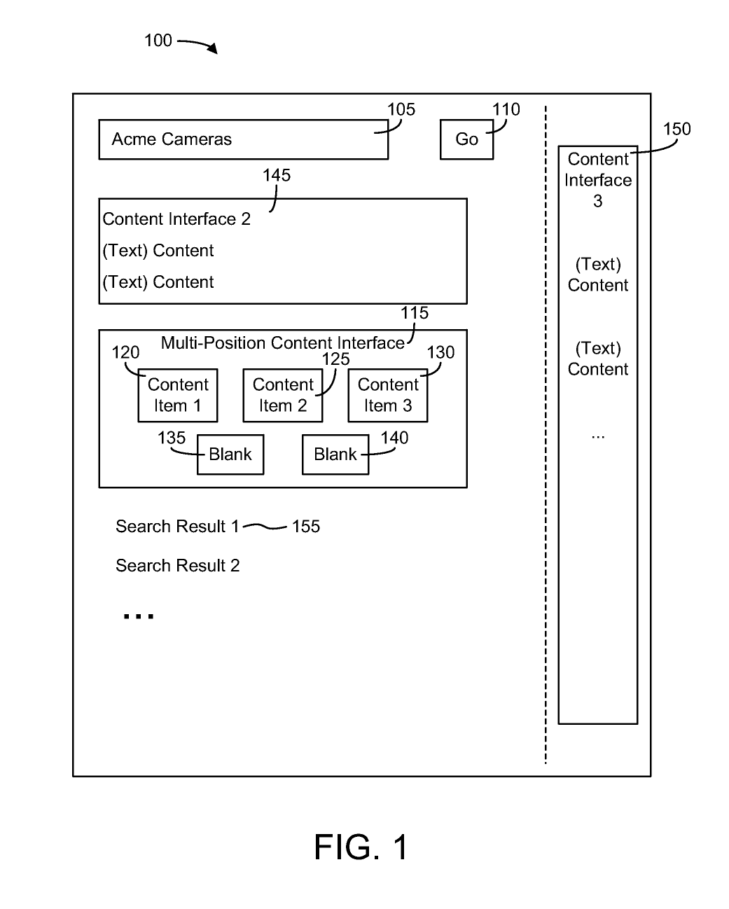

One example display image of a search results screen 100 including several content interfaces is shown in FIG. 1 according to an illustrative implementation. Screen 100 includes a search input 105 and a search button 110. Upon submitting a search query, several search results 155 may be displayed to the user. One or more other content interfaces may be displayed to the user as well. For example, a content interface 145, shown just under search input 105, and content interface 150, shown on a right side of screen 100, may provide textual content items to a user. In some implementations, interfaces 145 and/or 150 may display other types of content, such as images or video, to the user instead of or in addition to textual content. In some implementations, interfaces 145 and/or 150 may or may not have a set number of positions in which content items may be displayed. Screen 100 also includes a multiple position content interface 115 that has five positions in which content items may be placed. In the illustrated embodiment, positions 120, 125, and 130 include content items, while positions 135 and 140 remain blank. The inventors of the present disclosure have discovered that providing a full slate of content items (i.e., five out of the maximum five results) performs best in terms of user engagement, revenue for the auctioneer managing the auction, and traffic for the content providers who are bidding to have the content items displayed.

One form of auctioning that is often used in content auction systems is slate level auctions. In such auctions, the results are all forced to meet a set of minimum auction criteria (e.g., minimum relevance, minimum predicted click through rate, etc.), and only the qualifying content bids are sorted and priced based on their utility to the auctioneer and presented to the user. This type of auction can result in fewer than a full slate of content items being displayed within the content interface when less than the maximum number of items meet the minimum criteria.

Some illustrative implementations of the present disclosure provide content auction systems that allow for minimum eligibility criteria, such as minimum predicted click through rates, to be enforced while increasing the likelihood that a full (or more full) slate of content items will be displayed within the content interface. The auction system is configured to apply different eligibility criteria to different positions within the content interface, for example in an effort to more closely model the eligibility criteria for each position to the incremental cost associated with showing another result in the position. The inventors have discovered that once the decision has been made to show a first result within the interface, the cost associated with displaying additional items (e.g., the reduced likelihood of a user clicking on other portions of the displayed resource, such as items in content interfaces 145 and/or 150 in FIG. 1) is substantially less than the cost associated with displaying the first content item.

A content auction system according to some implementations of the present disclosure is configured to perform separate auctions for different positions within the interface and apply different eligibility criteria (e.g., different threshold values) to two or more of the auctions. In some implementations, a first set of eligibility criteria may be applied to the auction for the first position, and one or more second auctions may be applied for the remaining positions using a different set of eligibility criteria. In some implementations, a separate auction may be held for each position, and a separate set of eligibility criteria may be applied for each position. In some implementations, the eligibility criteria for one position (e.g., a second position) may be determined based on the eligibility criteria for the prior position (e.g., a first position). Any type of scheme or function may be used to determine the thresholds applied at different positions. For example, a linearly decreasing threshold may be applied in which the threshold is decreased by a constant amount for each position (e.g., 0.5% predicted click through rate, or pCTR, for the first position, 0.45% pCTR for the second position, 0.4% pCTR for the third position, etc.). In another example, an exponentially decreasing threshold scheme may be applied to each position. In some implementations, historical data may be used to determine appropriate thresholds (e.g., historical cost data associated with showing three results versus showing four results), which may allow the thresholds to be more closely correlated with the incremental cost associated with displaying additional content items within the interface.

Some illustrative implementations of the present disclosure provide a content auction system that allows diversity requirements to be enforced while increasing the likelihood that a more full slate of content items will be displayed within the content interface. It may be desirable to provide a relatively high level of diversity along one or more dimensions within the content interface. Because there are a limited number of positions available in which to display content items, the auctioneer may wish to avoid having too many of the positions filled with content items associated with the same merchant/brand/product/etc. Some auction systems may achieve diversity by applying filters, or eligibility criteria, that prevent multiple content items associated with a filtered dimension from all being eligible for the auction, or from all winning the auction. For example, the auction system may apply a filter allowing only one content item associated with each merchant to be eligible for an auction of the available positions in the content interface, or to be selected as a winning bid within the content interface. In one such example, a content interface may have eight available positions and there may be 12 content bids to fill the positions, seven of which are associated with a single merchant. Applying the “one merchant” rule, the auction system would determine that only one of the seven bids associated with the merchant to be eligible for the auction, leaving only six of the 12 content bids eligible for the auction of the eight available positions. Accordingly, in such an example, two positions in the content interface would be unfilled, resulting in a missed opportunity for the user, the auctioneer, and the content providers (e.g., merchants) submitting the content bids.

Some implementations of the present disclosure provide a content auction system that can achieve the same level of diversity as the conventional system described above while increasing the likelihood that a full (or more full) slate of content items will be displayed within the content interface. In some implementations, the auction system may be configured to fill the positions using per position auctions in which each position is filled using a separate auction process. In such implementations, the auction system may run a standard auction on each position with full constraints (e.g., only one merchant per position). For each position, if the auction with full constraints yields a winning bid, the content item associated with that bid may be selected for the position and the auction for the next position may be run. If the auction with full constraints does not yield a winning bid (e.g., if all merchants represented within the eligible bids are already covered by winning bids that were selected for previous positions), a fallback auction for the position may be run with relaxed constraints. For example, the fallback constraints may specify that there is no limit to how many content items can be associated with a particular merchant, or that there is a higher limit than is associated with the full constraints (e.g., a maximum of five items associated with a single merchant instead of only one). In some implementations, multiple incremental fallback auctions may be performed to gradually relax the constraints. For example, standard constraints may require only one item per merchant, a first set of relaxed constraints for a first fallback auction may require only three items per merchant, and a second set of relaxed constraints for a second fallback auction may allow any number of items per merchant.

In some implementations, the fallback auction mechanism may be extended to allow for diversification across multiple dimensions of constraints (e.g., merchants, brands, products, images, other content within the content item, etc.). The auction system may be configured to conduct a series of cascaded fallback auctions for a position until a winning bid is identified or all desired combinations of constraints have been exhausted. The auction system may define a series of constraint combinations to be used in fallback auctions when the standard auction does not yield a winning bid for a position. For example, the auction system may apply three dimensions of diversity-related constraints to limit the number of items related to each merchant, each brand, and each product. In a first fallback auction, the auction system may disable the constraint limiting the number of items per merchant but keep the constraints relating to the brands and products enabled. In a second fallback auction, the auction system may disable the constraint relating to the brands and enable the constraints relating to the merchants and products. In a third fallback auction, the auction system may disable the constraints relating to the merchants and brands and enable the constraint relating to the products. Any set of constraint combinations may be applied across separate fallback auctions to try and identify a winning bid to fill the position.

In some implementations, the auction system may be configured to apply fallback auctions across more than one position at a time. For example, an auction may be run to determine winning bids for all or some of the positions at one time (e.g., a slate-level auction). In such an implementation, the auction may be run with full constraints, and if all of the positions are not filled with the full constraints, a fallback auction may be run with a relaxed set of constraints to determine if all or more of the positions are filled. Accordingly, the disclosure applies equally to auction systems that use per-position auction processes and those that fill multiple positions with a single auction process.

In some implementations, the auction system may be configured to implement varying constraints at different positions for both diversity-related constraints and performance-related constraints (e.g., based on or related to a predicted click through rate or other performance metric). For example, the auction system may be configured to conduct at least one auction process for each position, and both diversity and performance constraints may be applied to bids to determine eligible bids for each auction. If a winner cannot be determined, either the diversity constraint, the performance constraint, or both may be relaxed or deactivated in an effort to identify a winning bid for the position. In some embodiments, the diversity constraint may be relaxed across multiple fallback auctions for a single position, and different performance thresholds may be applied in auctions for different positions.

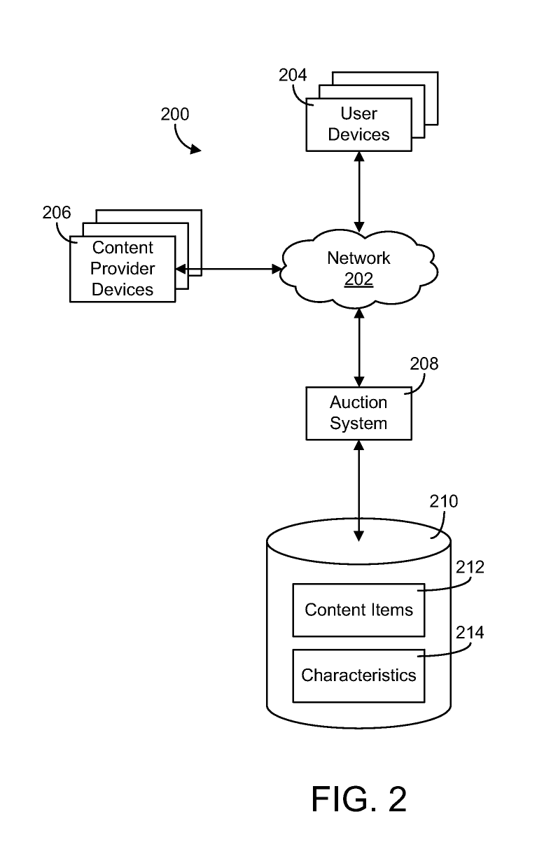

Referring now to FIG. 2, and in brief overview, a block diagram of an auction system 208 and associated environment 100 is shown according to an illustrative implementation. One or more user devices 204 may be used by a user to perform various actions and/or access various types of content, some of which may be provided over a network 202 (e.g., the Internet, LAN, WAN, etc.). For example, user devices 204 may be used to access websites (e.g., using an internet browser), media files, and/or any other types of content. Auction system 208 may be configured to select content for display to users within resources (e.g., webpages, applications, etc.) and to provide content items 212 from a content database 210 to user devices 204 over network 202 for display within the resources. The content from which auction system 208 selects items may be provided by one or more content providers via network 202 using one or more content provider devices 206.

In some implementations, bids for content to be selected by auction system 208 may be provided to auction system 208 from content publishers participating in an auction using devices, such as content provider devices 206, configured to communicate with auction system 208 through network 202. In such implementations, auction system 208 may determine content to be published in one or more content interfaces of resources (e.g., webpages, applications, etc.) shown on user devices 204 based at least in part on the bids. In some implementations, certain characteristics 214 of a content campaign associated with the bids, such as performance characteristics (e.g., predicted click through rate), merchant associated with the content, product name/type/characteristics for the product(s) features in the content, brands (e.g., logos, names, etc.) featured in or affiliated with the content, and/or other characteristics, may be stored in content database 210 and/or another data storage element.

Referring still to FIG. 2, and in greater detail, user devices 204 and/or content provider devices 206 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 204 may be set-top boxes or other devices for use with a television set. In some implementations, content may be provided via a web-based application and/or an application resident on a user device 204. In some implementations, user devices 204 and/or content provider device 206 may be designed to use various types of software and/or operating systems. In various illustrative implementations, user devices 204 and/or content provider device 206 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 204 and/or content provider device 206 may be configured to receive data from various sources using a network 202. In some implementations, network 202 may comprise a computing network (e.g., LAN, WAN, Internet, etc.) to which user devices 204 and/or content provider device 206 may be connected via any type of network connection (e.g., wired, such as Ethernet, phone line, power line, etc., or wireless, such as WiFi, WiMAX, 3G, 4G, satellite, etc.). In some implementations, network 202 may include a media distribution network, such as cable (e.g., coaxial metal cable), satellite, fiber optic, etc., configured to distribute media programming and/or data content.

Auction system 208 may be configured to conduct a content auction among third-party content providers to determine which third-party content is to be provided to a user device 204. For example, auction system 208 may conduct a real-time content auction in response to a user device 204 requesting first-party content from a content source (e.g., a website, search engine provider, etc.) or executing a first-party application. Auction system 208 may use any number of factors to determine the winner of the auction. For example, the winner of a content auction may be based in part on the third-party content provider's bid and/or a quality score for the third-party provider's content (e.g., a measure of how likely the user of the user device 204 is to click on the content). In other words, the highest bidder is not necessarily the winner of a content auction conducted by auction system 208, in some implementations.

Auction system 208 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 204. In some implementations, the bid amount may be on a cost per impression or cost per thousand impressions (CPM) basis. In further implementations, a bid amount may correspond to a specified action being performed in response to the third-party content being presented at a user device 204. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of the user device 204 making a purchase. Such bids are typically referred to as being on a cost per acquisition (CPA) or cost per conversion basis.

A campaign created via auction system 208 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other example parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of an particular online newspaper.

Auction system 208 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, auction system 208 may suggest that a third-party content provider increase or decrease their bid amount for desktop devices by a certain percentage, to create a bid amount for mobile devices.

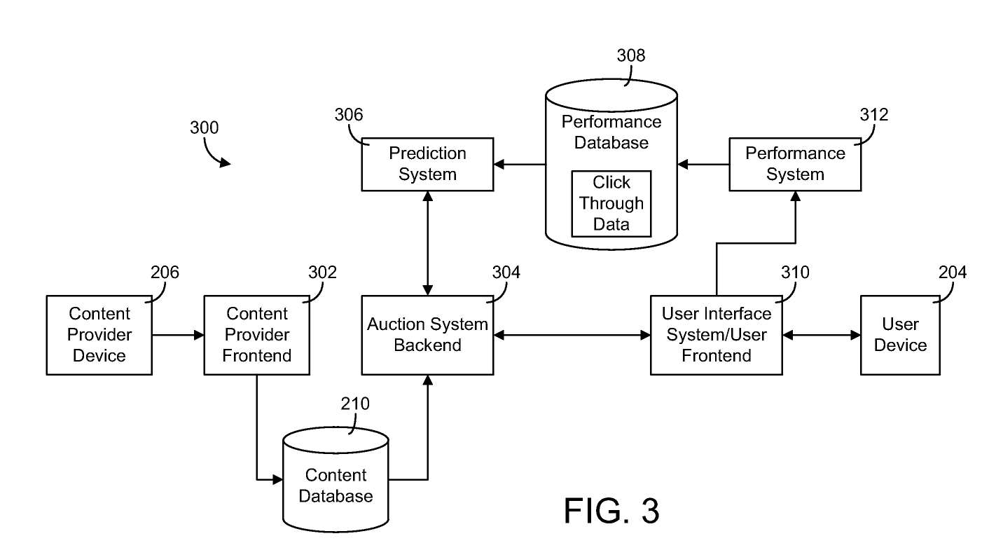

Referring now to FIG. 3, a more detailed block diagram of an auction system 300 and associated environment is shown according to an illustrative implementation. In the illustrated implementation, auction system 300 includes a content provider frontend 302, an auction system backend 304, a prediction system 306, a user interface system 310 (e.g., user frontend), a performance system 312, and a performance database 308. It should be understood that auction system 300, which is a detailed implementation of auction system 208 according to one implementation, is provided for purposes of illustration, and in other implementations, auction system 208 may include additional, fewer, and/or different components. Further, each of the illustrated systems and/or components may be implemented as a separate computing system, multiple systems may be combined within a single hardware system, and/or one or more systems or components may be implemented in a cloud, or distributed computing, environment.

Bids submitted by a content provider device 206 may be received by content provider frontend 302. Content provider frontend 302 may then store data representing the bids (e.g., content campaign and associated items, bid value, characteristics of the content campaign, etc.) within content database 210. Actions performed by a user on a user device 204 may be received via user interface system 310. The actions may be or include, for example, navigating to a webpage, entering a search within a search engine, opening or using an application, etc. When the action is an action that causes auction system 300 to provide content items for display on user device 204, data representing the action may be transmitted from user interface system 310 to auction system backend 304 to conduct one or more auctions to select appropriate content items from among the submitted content bids.

Auction system backend 304 may be configured to retrieve the bid data from content database 210 and conduct one or more auction processes to determine winning bids from which the content items will be selected. Auction system backend 304 may have access to an index of all candidate content bids stored in content database 210. Auction system backend 304 may send data relating to the candidate bids to prediction system 306, which may generate predicted performance scores and/or other data relating to the bids. In some implementations, auction system backend 304 may perform some preliminary processing to eliminate some candidate bids before sending the candidate bid data to prediction system 304. For example, auction system backend 304 may apply diversity constraints to eliminate any bids that are not eligible for the auction because they share campaign characteristics with other previously selected winning bids or other bids in the pool of eligible bids, as will be described in further detail later in the present disclosure.

Prediction system 306 may generate predicted performance-related data for each of the candidate bids. The predicted performance data may include a quality score, such as a predicted click through rate, or pCTR, which may represent or be related to a likelihood that the user will click on or otherwise select the content item associated with the bid if it were presented within the content interface. In some implementations, the quality score may be based on characteristics of the content item (e.g., subject matter of the content item, price category of product being featured in the content item, etc.) and/or comparison of such characteristics to characteristics of the user viewing the item and/or of the resource in which the content interface is displayed. In some implementations, the quality score may be based in part on historical data relating to similar bids and/or content items, such as a rate at which users with similar characteristics clicked through similar items displayed within similar portions of content interfaces presented to the users in the past. In some implementations, this historical data may be stored in a performance database 308. Once the predicted performance data has been generated, it may be submitted back to auction system backend 304.

Auction system 304 may conduct one or more auctions to select the winning bids and transmit data representative of the winning content items to user interface system 310. User interface system 310 may render the resource (e.g., webpage) including the content interface with the selected content items and transmit data representing the rendered resource to the user device 204 for presentation to the user. Data representing interactions of the user with the displayed content items on user device 204 may be transmitted back to user interface system 310 and may be transmitted to a performance system 312 (e.g., a click server), which may store data relating to the displayed content items and/or content interface and the resultant interaction of the user within performance database 308. The data may be used to generate future performance predictions by prediction system 306.

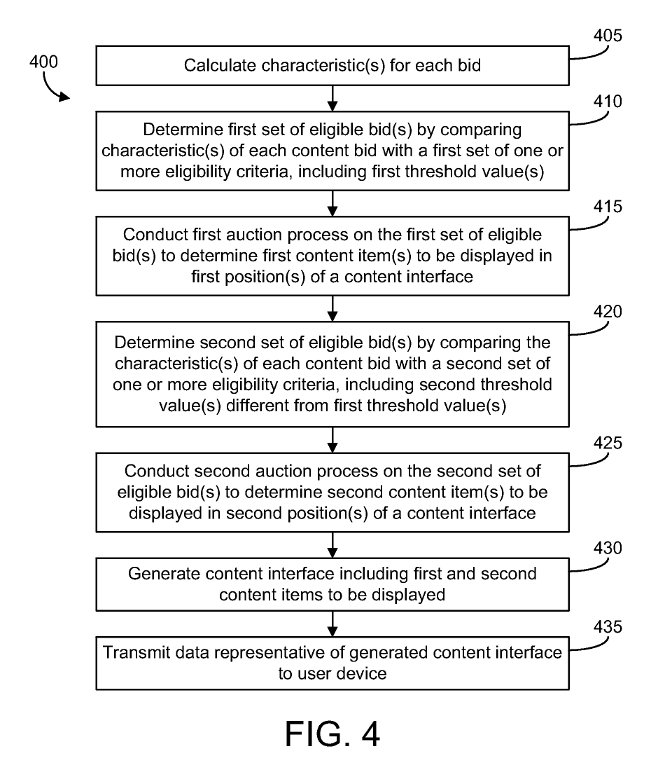

In some implementations, auction system 208 may be configured to select content items for different positions of a multiple-position content interface by conducting separate auction processes for different positions or groups of positions and applying different eligibility criteria (e.g., predicted performance criteria) to candidate bids to determine eligible bids for the auction processes. FIG. 4 illustrates a flow diagram of a process 400 for selecting content to include in a multiple-position content interface using different threshold eligibility values for different positions according to an illustrative implementation. Referring to both FIGS. 2 and 4, auction system 208 may retrieve data relating to two or more candidate bids for consideration when determining content items to display within the content interface. The content interface may have two or more positions, each of which may be filled with a content item to be displayed to a user (e.g., text and/or media content items, such as an image and associated text). In some embodiments, some or all of the operations of process 400 may be performed in response to a single request to provide content items for the content interface (e.g., single search query, single request from a resource, such as a webpage, that includes the content interface, etc.).

Auction system 208 may calculate or otherwise determine one or more characteristics (e.g., performance characteristics, such as quality score and/or utility score) for the content campaign associated with each bid (405). For example, auction system 208 may calculate a quality score (e.g., a predicted click through rate, or pCTR) for each bid. In some implementations, auction system 208 may calculate a utility score, which may be based on both the quality score and the bid value of the bid (e.g., the monetary value the content provider has bid for displaying the content within the content interface). For example, in some implementations, the utility score may be defined as the quality score (e.g., pCTR) multiplied by the bid value. In some implementations, the utility score may be represented as a monetary value, such as an expected cost per thousand impressions, or ECPM.

Auction system 208 may determine a first set of one or more eligible bids by comparing one or more characteristics (e.g., performance characteristics) of a content campaign for each bid with a first set of one or more eligibility criteria (410). The eligibility criteria may include a first threshold value, such as a first minimum quality score or utility score. In some implementations, the eligibility criteria may include a minimum relevance score. A relevance score may quantify the estimated relevance of the content item associated with a bid to the context in which the content interface is presented. For example, the relevance score may be based on how many words of a user search query overlap with keywords associated with the bid, how closely the subject matter of the bid content item relates to a resource in which the content interface is being presented and/or interests of the user as reflected within a user profile, and/or other factors. In some embodiments, as will be described in further detail later herein, the eligibility criteria may include one or more diversity factors or filters designed to prevent several winning content items/campaigns from being too similar or sharing too many common characteristics.

Auction system 208 may determine the first set of eligible bids at least in part by applying a first threshold quality or utility score. For example, the first set of eligible bids may be determined by eliminating any candidate bids (e.g., any bids deemed “relevant” to the context in which the content interface is being presented, such as bids having a relevance score above a certain value) that have a utility score under a particular value (e.g., 0.5). The remaining bids that have not been eliminated may be determined to be eligible bids for the first auction. Auction system 208 may then conduct a first auction process on the first set of eligible bids to determine one or more first content items to be displayed in one or more positions within the interface (415). In some implementations, auction system 208 may select one or more eligible bids having the highest utility scores or highest bid values as the winning bids to fill the interface positions that are designated to be filled by the first auction process.

Auction system 208 may determine a second set of eligible bids by comparing one or more characteristics (e.g., performance characteristics of an associated content campaign) of each candidate bid with a second set of one or more eligibility criteria (420). The second set of eligibility criteria may include a second threshold value, such as a second quality or utility score, that is different from the first threshold value. For example, auction system 208 may determine the second set of eligible bids by eliminating any candidate bids having a utility score under 0.4, and the remaining bids may be determined to be eligible bids for the second auction. Auction system 208 may then conduct a second auction process on the second set of eligible bids to determine content items to be displayed in one or more positions of the interface that were not filled using the first auction process (425). Using a lower threshold for the second auction process may increase the likelihood that one or more positions that would have gone unfilled under the higher threshold will be filled under the lower threshold. In some implementations, if the second auction process does not result in a winner, or results in less winning bids than positions that need to be filled, the second auction process may be re-run with a lower threshold value, or a separate auction process may be run to fill the remaining unfilled positions. In some implementations, the unfilled positions may remain unfilled. While two auction processes have been described above, any number of auction processes may be used to fill the interface positions with content items. Once the auctions have been conducted, the content interface including the content items selected through the auctions may be generated (430) and data representative of the generated content interface may be transmitted to the user device (435). In response, the user device may display the resource, including the content interface, to the user.

The number of interface positions filled by the first auction process may vary according to different illustrative implementations. For example, in some implementations, auction system 208 may be configured to attempt a slate level auction for the first auction process and try to fill all positions of the interface with the same eligibility criteria applied to all candidate bids. If the slate level auction results in less eligible bids under the standard eligibility criteria than available positions in the interface, auction system 208 may either run one or more second auction processes to fill the empty positions or discard the slate level auction results altogether and conduct at least two separate auctions with different eligibility thresholds. In some implementations, the first auction process may be used to determine winners for a first set of positions (e.g., the first two positions of an interface), and the second auction process may be used to determine winners for a second set of positions (e.g., the last three positions of the interface).

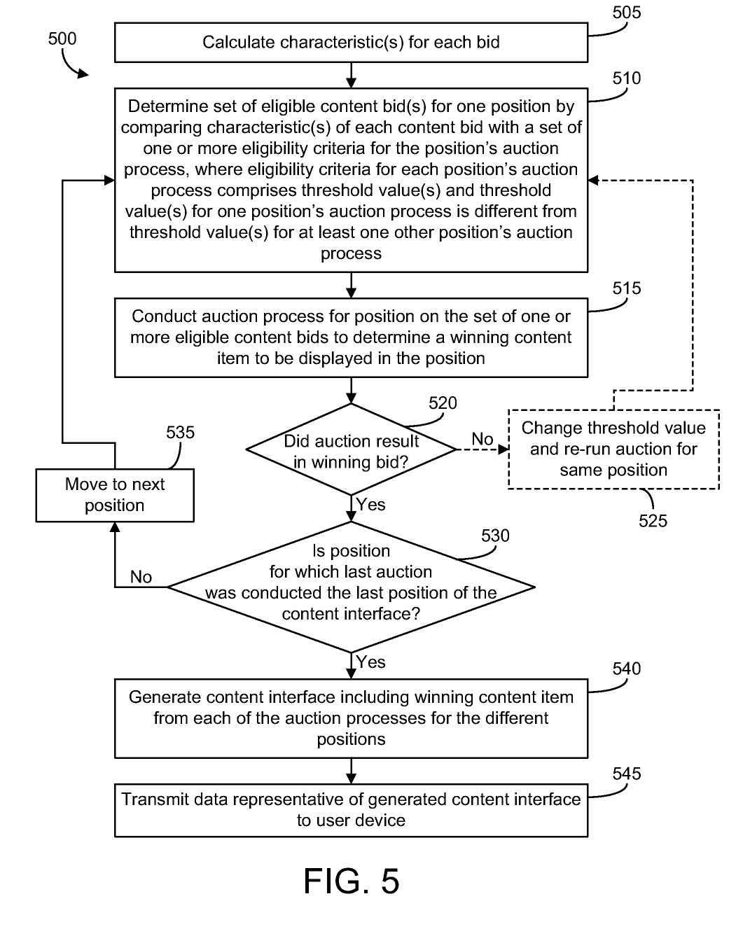

In some implementations, a separate auction process may be used to determine a winner for each position in the interface. FIG. 5 is a flow diagram of a process 500 for selecting content items to include within a multiple-position content interface using different eligibility threshold values for different positions and a separate auction process for each position according to an illustrative implementation. Process 500 may be considered a specific illustrative implementation of process 400 in which a separate auction, including separate eligibility criteria, is used for each position of the content interface. The auction processes discussed with respect to FIG. 5 may be described as per-position auctions. In some implementations, process 500 may be configured to accurately model the incremental cost of showing a new result in a blank position within the interface (e.g., in terms of the lost click opportunity in another portion of the resource, such as another part of the content interface or another content interface) based on the number of winning results that have already been selected so far. In some embodiments, some or all of the operations of process 500 may be performed in response to a single request to provide content items for the content interface.

Auction system 208 may be configured to calculate or otherwise determine one or more characteristics, such as performance characteristics of an associated content campaign (e.g., a quality score, such as pCTR, and/or utility score), for each candidate bid (505). Auction system 208 may then conduct a separate auction system for each position within the content interface. Auction system 208 may determine a set of one or more eligible content bids for a first position in the interface (e.g., a most significant or most valuable position, such as a left-most and/or top-most position within the interface) by comparing one or more campaign characteristics of each candidate content bid with a set of one or more eligibility criteria for the first position's auction process (510). The eligibility criteria for the first position may include a first threshold value, such as a first minimum quality score (e.g., pCTR) or first minimum utility score. For example, the first threshold value may be a minimum pCTR of 0.5%, and any candidate bids having a pCTR under 0.5% may be eliminated from the auction for the first position.

An auction process for the first position may be conducted on the remaining eligible bids to determine a content item to be displayed in the first position (515). Once the first auction process has been completed, auction system 208 may determine whether the auction resulted in a winning bid for the first position. In some implementations, if the auction process did not result in a winning bid, auction system 208 may adjust (e.g., lower) the threshold value and re-run the auction for the same first position according to operations 510 and 515. In some implementations, if the auction process did not result in a winning bid, auction system 208 may end the auction process without selecting a winning bid for the position. In the event that no winning bid is identified for the first position, auction system 208 may not display the content interface in the resource.

If the auction process did result in a winning bid, the content item associated with the winning bid may be designated as the content item to appear in the associated position of the content interface. Auction system 208 may then determine if the position for which the last auction was conducted is the last position in the content interface (530). If the position associated with the last auction is not the last position, auction system 208 may move to the next position in the interface (535) and conduct a separate auction for the next position, repeating operations 510, 515, 520, 530, and, possibly, 525 and/or 535. If the position for which the last auction was conducted is the last position in the interface, the content interface including the winning content item from each of the auction processes for the different positions may be generated (540) and data representative of the generated content interface may be transmitted to the user device (545).

Different eligibility criteria may be applied for the auction processes associated with different positions. For example, at least one of the position's auction processes may determine eligible content bids based on a different threshold value (e.g., different pCTR) than the threshold value applied for at least one other position. In some implementations, the threshold value may vary across most of or all of the different position auction processes. For example, a quality score threshold for a first position may be 0.5% pCTR, a quality score threshold for a second position may be 0.4% pCTR, a quality score threshold for a third position may be 0.3% pCTR, and so on.

In some implementations, the threshold values may be determined as a function of the position associated with each threshold value, as follows:

T_{—}i=f(T_base,i,T_min)

In the above, ‘f’ is a function that returns the threshold for position ‘i’ given the base, or standard, threshold T_base, position i and a minimum allowable threshold T_min. In some implementations, if the value that would be returned under function f would be less than T_min, the value T_min is returned.

In some implementations, the thresholds for different positions may be determined according to a linear function, such as the following:

T_{—}i=max(T_base−(slope*i),T_min)

In the above, T_i represents the threshold for position i, where i=0 is the first, or most significant, position, T_base represents the base threshold, or threshold value for the first position, T_min represents the minimum threshold allowed for any position, and slope is the amount by which the threshold is to be lowered at each successive position.

In some implementations, the thresholds for different positions may be determined according to an exponential function, such as the following:

T_{—}i=max(T_base*multiplier̂i,T_min)

In the above, multiplier may be a value that is less than or equal to 1.0, such that the expression multiplier̂i decreases, and causes the threshold to decrease, exponentially from one position to the next. While linear and exponential functions for determining thresholds across different positions are presented herein for purposes of illustration, it should be understood that any type of function may be used to determine the different thresholds to be applied at different positions, and all such functions are contemplated within the present disclosure. Additionally, thresholds may not always decrease with increasing position. For example, if an interface includes ten positions distributed over two rows, with positions one through five in the first row and positions six through ten in the second row, the threshold associated with position six, the first position in the second row, may be higher than a threshold associated with position five, the last position in the first row.

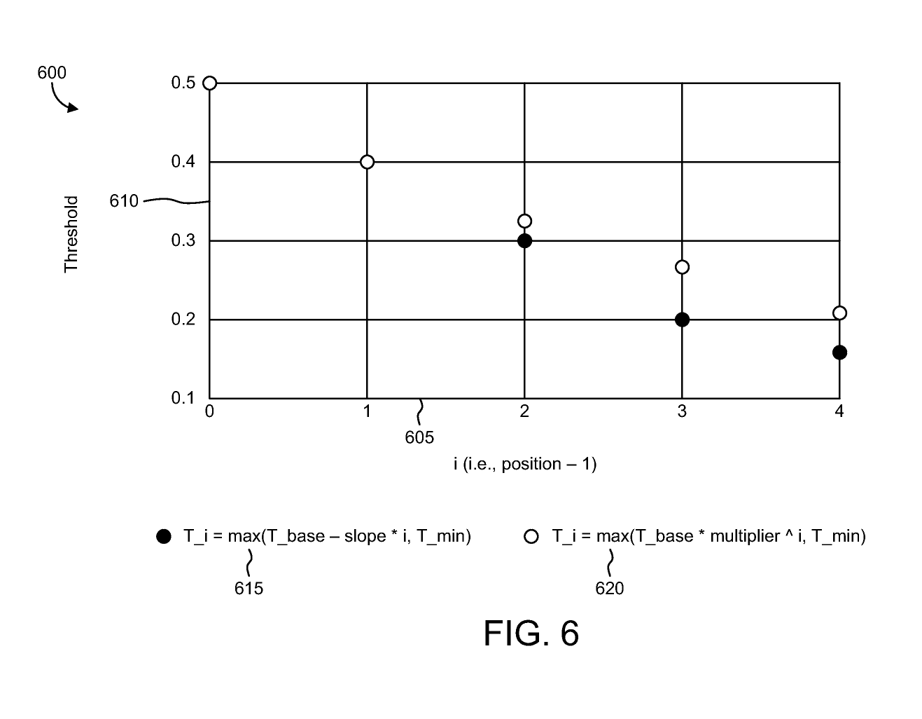

FIG. 6 is a graph 600 that illustrates the different thresholds for different positions using the linear and exponential functions described above, according to an illustrative implementation. An x-axis 605 represents positions within the content interface, and a y-axis 610 represents threshold quality scores in % pCTR. Dark circle plot points 615 represent the linear function, and light circle plot points 620 represent the exponential function. T_base=0.5% pCTR, slope=0.1, multiplier=0.8, and T_min=0.16% pCTR. For the linear function, T_{—}0=0.5, T_{—}1=0.4, T_{—}2=0.3, T_{—}3=0.2, and T_{—}4=0.16, because the threshold obtained under the linear function for the last position, 0.1, is less than the minimum threshold. For the exponential function, T_{—}0=0.5, T_{—}1=0.4, T_{—}2=0.32, T_{—}3=0.256, and T_{—}4=0.2048. The threshold values decrease more slowly as the positions increase under the exponential function as compared to the linear function. In both instances, the thresholds lower substantially for later positions, reflecting the decreasing incremental cost of adding an item in a later position once the decision has been made to display the content interface and/or to display an item in an earlier position.

In some implementations, instead of using predetermined functions to determine the varying threshold values at different positions, auction system 208 may be configured to compute the thresholds empirically using historical data. For example, to determine a threshold for a position i, auction system 208 could on a portion of traffic (e.g., randomly chosen) choose to show either i results or i−1 results, and the difference in utility of the two sample data sets could influence the value of T_i.

For instance, on about a million queries, where auction system 208 could have shown four results, auction system 208 may show only three results. In another million queries of the same type, auction system 208 may show four results. If showing four results (out of a maximum of five) instead of three would result in an increase in revenue per query of $x, clicks to merchants/content providers by y clicks per 1000 queries, and user-perceived relevance by z relevance-units, then that could influence the threshold as follows, according to one illustrative implementation:

T_{—}i=f(utility-to-auctioneer,utility-to-merchant,utility-to-user,T_min)

In the above, the thresholds are determined as a function of the utility to all three of the auctioneer, the merchant, and the user. In some implementations, the thresholds may be determined by less than all three of these entities.

In some implementations, bias in the collected data may skew the accuracy of the calculated threshold values. For example, particular queries may result in higher revenue for the page in a way that is unrelated to the number of positions in which items are displayed. For example, in some circumstances, displaying four items in the interface may result in higher revenue for the rest of the content interfaces in the resource than displaying three items, when displaying three items normally should result in higher revenue for the other content interfaces in the resource (because they are competing with fewer alternative content items). One way of removing or reducing this bias is to randomly drop some of the results before calculating the threshold values.

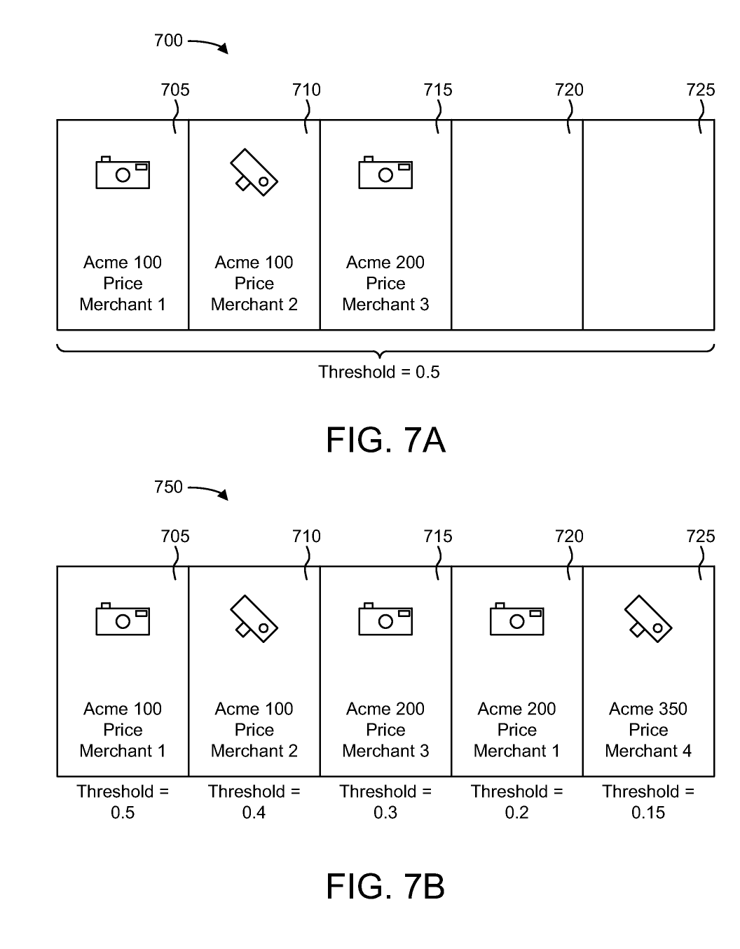

FIGS. 7A and 7B show example display images of a multiple-position content interface that illustrate the potential effect of processes 400 and/or 500 according to an illustrative implementation. FIG. 7A shows a display image 700 illustrating the interface in which a single threshold minimum pCTR value of 0.5% has been applied to select eligible bids for all positions (e.g., through a slate level auction). The interface includes five positions, and the candidate bids include two bids submitted by Merchant 1 and one bid submitted by each of Merchants 2, 3, and 4. In image 700, content items have been selected for positions 705, 710, and 715, but positions 720 and 725 remain empty after the auction because the second bid from Merchant 1 and the bid from Merchant 4 did not meet the minimum pCTR threshold of 0.5%.

FIG. 7B shows a display image 750 in which different thresholds have been applied to determine eligible bids for different positions, for example according to processes 400 and/or 500. The same three content items are selected for positions 705, 710, and 715. However, the second content item submitted by Merchant 1 is also selected for position 720, and the content item submitted by Merchant 4 is selected for position 725. Because the threshold values are lowered in this implementation for positions 720 and 725, bids are found to be eligible for the auctions for those positions that were not eligible under the slate level auction shown in FIG. 7A.

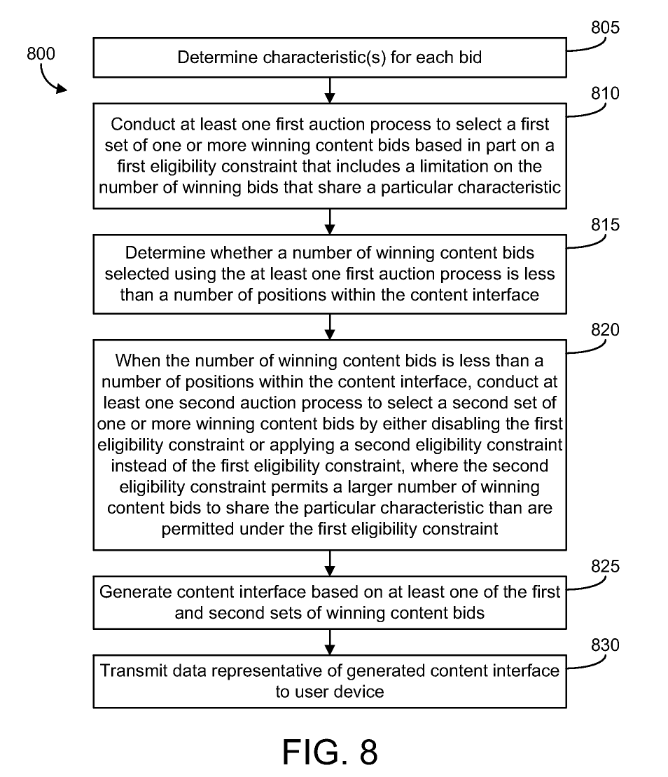

In some illustrative implementations, auction system 208 may additionally or alternatively be configured to apply diversity requirements or filters to determine eligible bids for one or more auctions. Referring now to FIGS. 2 and 8, a flow diagram of a process 800 that auction system 208 may use to select content to include in a multiple-position content interface using diversity filters that vary across positions is shown according to an illustrative implementation. Diversity filters may help increase the likelihood of the user deeming the content items to be relevant and/or interesting by reducing the similarity of certain characteristics between the displayed items. For example, one diversity filter may dictate that no more than one winning bid may be from the same content provider or merchant, no more than one winning bid may feature the same product or brand, no more than two winning bids may feature the same image, etc. Applying such diversity filters in a slate level auction across all positions may cause there to be less eligible bids than available interface positions. By varying the diversity filters across the different positions, auction system 208 may achieve at least the same level or type of diversity as achieved under the slate level auction, but also increase the likelihood that more of the positions will be filled with content items. In some embodiments, some or all of the operations of process 800 may be performed in response to a single request to provide content items for the content interface.

Auction system 208 may be configured to determine one or more characteristics of a content campaign for each candidate bid (805). The characteristics may include a merchant or content provider who submitted the bid, a bid value or price, a name, type, and/or other characteristics of a product featured in the content items associated with the bid, a brand (e.g., name, logo, etc.) featured in the content item or associated with the bid, a price for the product (e.g., in a shopping content interface), and/or other types of characteristics.

Auction system 208 may conduct at least one first auction process (e.g., a slate level auction) to select a first set of one or more winning content bids based at least in part on a first eligibility constraint (e.g., diversity filter) (810). The eligibility constraint may include a limitation on the number of winning bids that may share a particular characteristic. For example, eligibility constraints may limit the number of winning bids that can share the same merchant, the same featured product or brand, the same types or categories of words or phrases, the same or similar images, etc. If more candidate bids share a particular characteristic than is permitted by the eligibility constraint or filter, candidate bids may be disqualified as potential winning bids once the maximum number of winning bids sharing the same characteristic have been selected.

Once the first auction process is completed, auction system 208 determines whether a number of winning content bids selected using the first auction process is less than a number of positions within the content interface (815). If the number of winning bids is not less than the number of positions, the standard auction with full diversity filters has resulted in a full content interface, and the content interface can be generated based on the first auction.

When the number of winning bids is less than the number of positions within the interface, auction system 208 may conduct at least one second auction process (e.g., fallback auction) to select a second set of one or more winning bids by either disabling the eligibility constraint applied in the first auction or applying a second eligibility constraint that is more relaxed than the first constraint (820). The second, relaxed eligibility constraint may permit a greater number of content bids to share a particular characteristic than is permitted under the first constraint. For example, if the first constraint allows no more than one winning bid per merchant, the second constraint may allow up to three winning bids per merchant. In some implementations, if the second auction still does not result in a full content interface, the constraint may be further relaxed or disabled and another auction may be conducted in an attempt to fill, or more completely fill, the interface. For example, both the first and second constraints may be disabled, or a third constraint may be enforced instead of the first and second constraints, where the third constraint allows a greater number of winning content bids to share the campaign characteristic.

Once the auctions are completed, the content interface may be generated based on at least one of the first and second sets of winning content bids (825). If the first auction resulted in a full interface, the generated content interface may include the results of the first auction and the subsequent auctions may not be conducted. If the first auction did not result in a full interface, the generated content interface may include results of the second auction. Once the content interface has been generated, data representative of the interface may be transmitted to the user device (830).

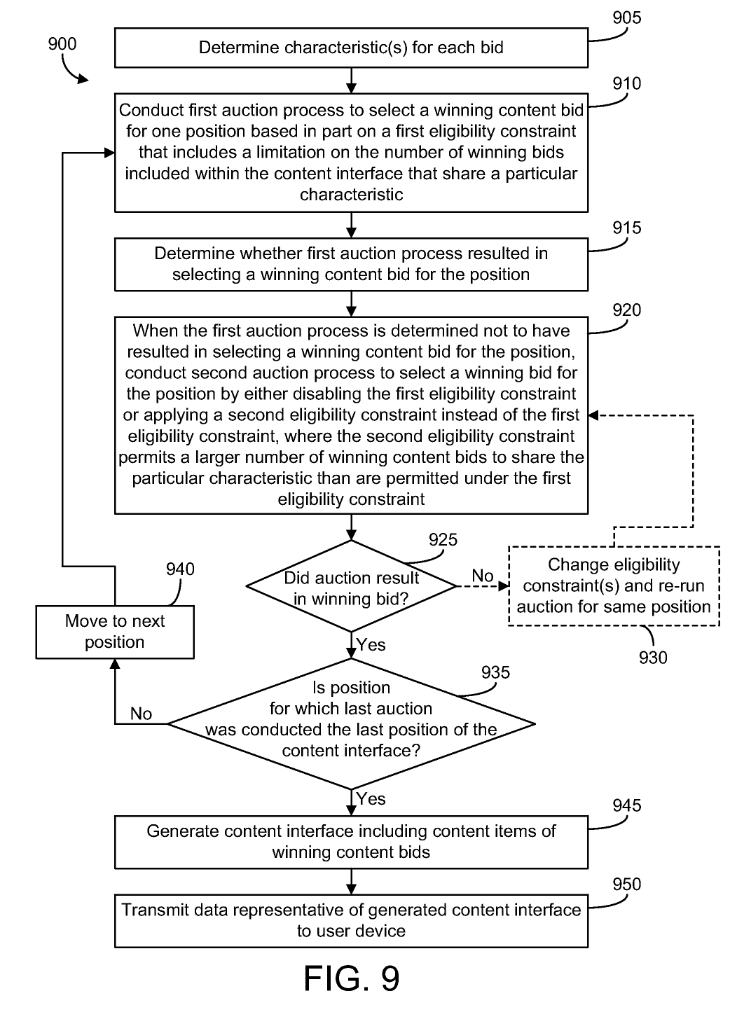

The at least one first auction process and at least one second auction process of process 800 may be used to determine winning bids for multiple positions at one time or the entire interface at once (e.g., in a slate level format). In some implementations, the first auction processes and/or second auction processes may be used to determine winners using separate auctions for each position (e.g., in a per-position auction format). FIG. 9 is a flow diagram of a process 900 for selecting content items to include within a multiple-position content interface using different diversity thresholds and at least one separate auction process for each position according to an illustrative implementation. Process 900 may be considered a specific illustrative implementation of process 800 in which at least one separate auction is used for each position. For each position, a full set of diversity constraints may be first applied and, if the full set of constraints prevents the initial auction from identifying a winner for the position, a relaxed set of constraints may be applied in a fallback auction. In some embodiments, some or all of the operations of process 900 may be performed in response to a single request to provide content items for the content interface.

Auction system 208 may determine campaign characteristics for each bid (905) and conduct at least one separate auction process for each position of the interface. Auction system 208 may conduct a first auction process to select a winning content bid for the first position based on a first eligibility constraint that includes a limitation on the number of winning bids that can share a particular characteristic (910). Auction system 208 may then determine whether the first auction process resulted in a winning bid for the position (915). If it did result in a winning bid, auction system 208 may proceed to the next position and run an auction with standard diversity constraints (e.g., operation 910) or, if the last auction was for the last position of the interface, generate the interface.

When the first auction process is determined not to have resulted in a winning bid for the position (e.g., due to diversity constraints), auction system 208 may conduct a second auction process to select a winning bid for the position by disabling the first eligibility constraint or applying a second, more relaxed eligibility constraint that permits a larger number of winning content bids to share the particular characteristic than are permitted under the first eligibility constraint. Auction system 208 may then determine whether the fallback auction process resulted in a winning bid for the position (925). If not, the constraint may be further relaxed or disabled and the auction may be re-run for the same position (930), or the content interface may be generated with one or more blank positions. If a winning bid is determined using the auction, auction system 208 may determine whether the position for which the last auction was conducted is the last position in the content interface (935). If not, auction system 208 may move to the next position (940) and repeat the auction process(es) for the next position (e.g., repeat operations 920, 915, 920, 925, 935, and, possibly, 930 and/or 940). If the position associated with the last auction is the last position of the interface, the interface may be generated to include the winning content bids (945) and data representative of the generated content interface may be transmitted to the user device (950).

In one illustrative implementation, process 900 may be represented in pseudo-algorithmic form as follows:

```
for (p = 0; p < Maximum-Positions; p++):
    Run the auction for the p-th position with the full set of constraints
    If that yields a winner: ← Run auction for next position
        p = p + 1
        continue
    Else:
        Repeat the auction for the same position with relaxed filters
        (e.g., no constraint) ← Relaxed Fallback Auction
        If that yields a winner: ← Run auction for next position
            p = p + 1
            continue
        Else:
            Terminate auction and return
```

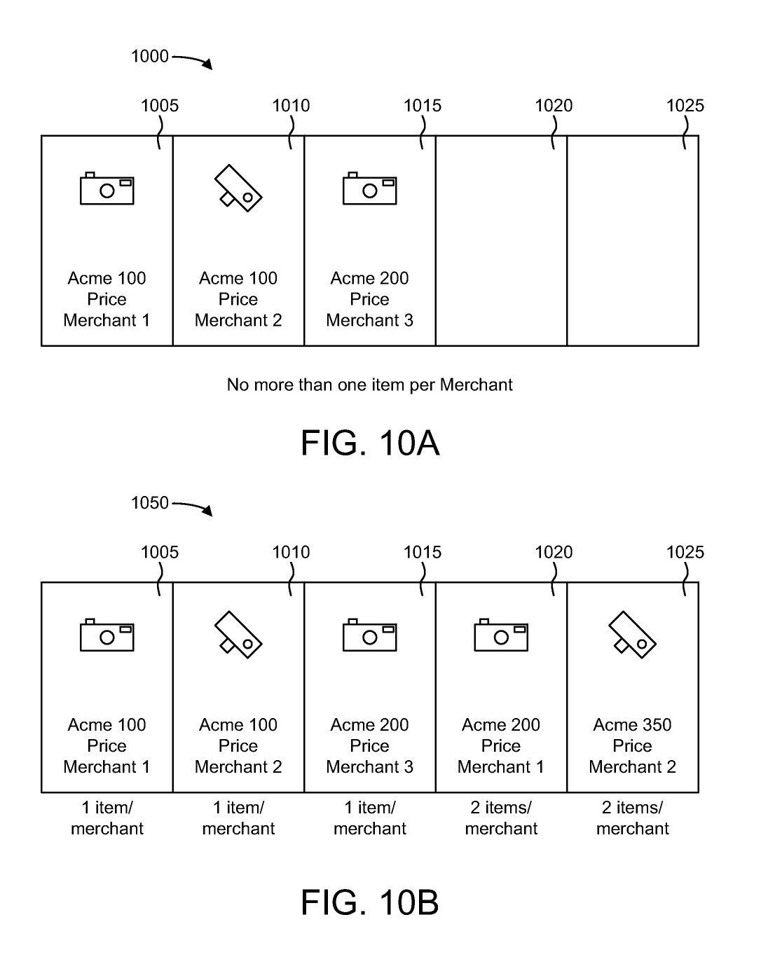

FIGS. 10A and 10B show example display images of a multiple-position content interface that illustrate the potential effect of processes 800 and/or 900 according to an illustrative implementation. FIG. 10A shows a display image 1000 illustrating the interface in which a slate-level auction is held with a diversity constraint that allows for only a single item per merchant in the winning items, with no fallback auctions. The interface includes five positions, and the candidate bids include two bids submitted by each of Merchants 1 and 2 and one bid from Merchant 3. Positions 1005, 1010, and 1015 are populated with items, but positions 1020 and 1025 remain blank because the second bids of Merchants 1 and 2 are ineligible under the diversity constraint.

FIG. 10B shows a display image 1050 of the interface in which one or more fallback auctions are used to relax or disable the diversity constraint, such as according to processes 800 and/or 900. The same three items are selected for the first three positions 1005, 1010, and 1015 under the same diversity constraint applied to all positions in the implementation shown in FIG. 10A. However, at least one fallback auction is conducted for positions 1020 and 1025 in which the diversity constraint is relaxed to allow two items per merchant, allowing the second bids submitted by Merchants 1 and 2 to be eligible for the fallback auction. The content items associated with those bids fill the remaining positions 1020 and 1025, providing the same type of diversity as in FIG. 10A but also providing a full content interface.

In some implementations, the fallback auction mechanism may be extended to allow for diversification across multiple dimensions of constraints (e.g., merchants, brands, products, images, other content within the content item, etc.). Auction system 208 may be configured to conduct a series of cascaded fallback auctions for a position until a winning bid is identified or all desired combinations of constraints have been exhausted. The auction system may define a series of constraint combinations to be used in fallback auctions when the standard auction does not yield a winning bid for a position. For example, the auction system may apply three dimensions of diversity-related constraints to limit the number of items related to each merchant, each brand, and each product. In a first fallback auction, the auction system may disable the constraint limiting the number of items per merchant but keep the constraints relating to the brands and products enabled. In a second fallback auction, the auction system may disable the constraint relating to the brands and enable the constraints relating to the merchants and products. In a third fallback auction, the auction system may disable the constraints relating to the merchants and brands and enable the constraint relating to the products. Any set of constraint combinations may be applied across separate fallback auctions to try and identify a winning bid to fill the position.

Such a multi-dimension cascaded fallback auction process may be represented in pseudo-algorithmic form, according to one illustrative implementation, as follows

```
for (p = 0; p < Maximum-Positions; p++):
    for (i = 0; i <= number of constraint-combinations; i++):
        Repeat the auction for the p-th position with the constraint
        combination ← i-th fallback auction
        If that yields a winner: ← Run auction for next position
            p = p + 1
            continue outer loop
        Else:
            Terminate auction and return ← all constraints were relaxed
            and we still have no winner
```

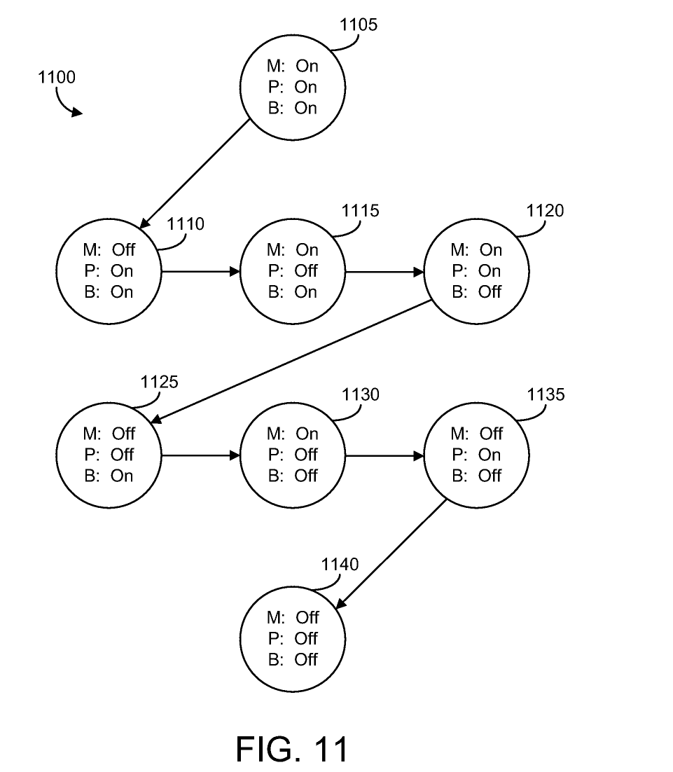

FIG. 11 illustrates an illustrative state diagram 1100 showing different combinations of diversity filters that may be applied in different fallback auctions to determine different sets of eligible content bids. Together, states 1105, 1110, 1115, 1120, 1125, 1130, 1135, and 1140 represent the different combinations of diversity constraints that may be applied to merchants, products, and brands associated with the different bids, assuming the filters are turned on and off and not adjusted (e.g., raising the maximum number from one to three). The total number of possible combinations is equal to (number of states/adjustments)̂(number of constraints) (e.g., in the illustrated implementation, 2̂3, or 8). In some implementations, such as those where a large number of constraints are applied or a large number of possible constraint adjustments are applied, less than every possible combination may be used in fallback auctions. For example, a hierarchy or list of the most relevant constraint combinations may be used in fallback auctions rather than every possible combination. In some implementations, the hierarchy may be determined in real-time or near real-time based on the context of the interface. For example, if a user query is related to cameras, the hierarchy may be designed to prioritize brand constraints. If a query is related to a particular brand of camera, the hierarchy may be designed to prioritize merchant constraints.

In some implementations, auction system 208 may be configured to implement varying constraints for both diversity-related constraints and performance-related constraints (e.g., based on or related to a predicted click through rate or other performance metric). For example, the auction system may be configured to conduct at least one auction process for each position, and both diversity and performance constraints may be applied to bids to determine eligible bids for each auction. If a winner cannot be determined, either the diversity constraint, the performance constraint, or both may be relaxed or deactivated in an effort to identify a winning bid for the position. In some embodiments, the diversity constraint may be relaxed across multiple fallback auctions for a single position, and different performance thresholds may be applied in auctions for different positions.

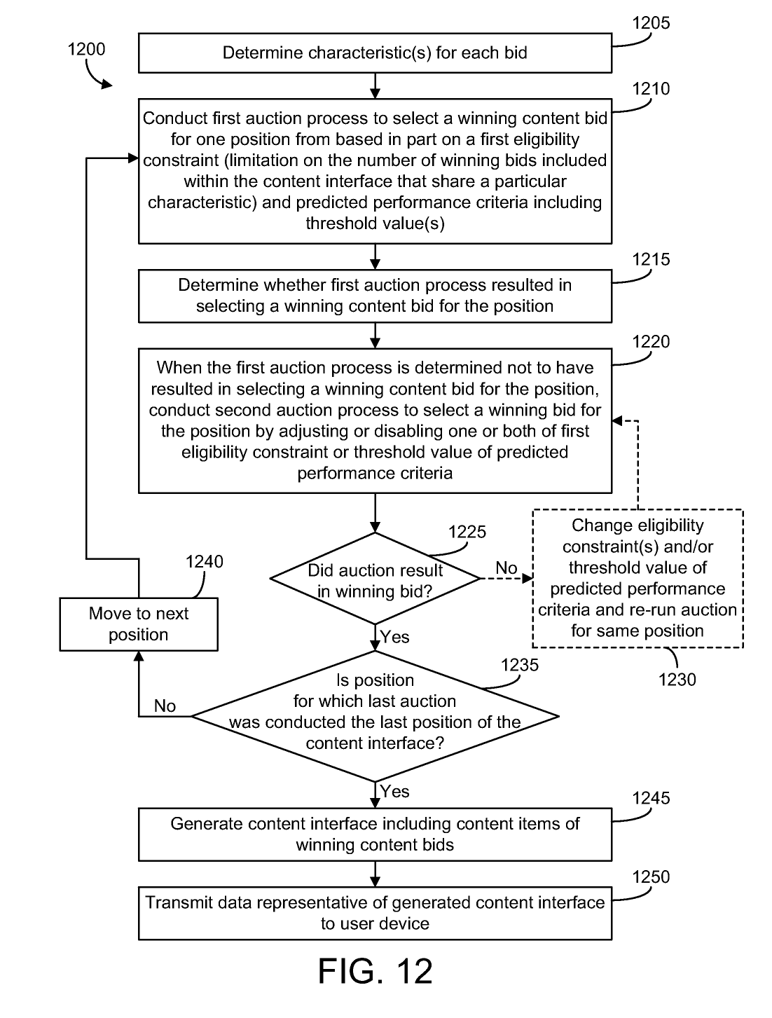

FIG. 12 shows a flow diagram of a process 1200 in which eligible bids may be restricted based on both diversity criteria and predicted performance criteria (e.g., related to pCTR) according to an illustrative implementation. Process 1200 utilizes per-position separate auctions to determine winners for each position. In some embodiments, some or all of the operations of process 1200 may be performed in response to a single request to provide content items for the content interface.

Auction system 208 may determine one or more campaign characteristics for each bid (1205) and conduct a first auction process to select a winning bid for a position based on both a first diversity constraint and a first predicted performance criteria, including a first threshold value (1210). Auction system 208 may determine whether the first auction process resulted in a winning content bid for the position (1215). If so, auction system 208 may move to the next position or generate the content interface (e.g., if the current position is the last position in the interface). If the first auction process did not result in a winning bid, auction system 208 may conduct a second auction process by adjusting or disabling one or both of the diversity constraint and the predicted performance threshold. Auction system 208 may then determine whether the second auction resulted in a winning bid (1225). If the second auction did not result in a winning bid, one or more additional fallback auctions may be conducted for the position to attempt to identify a winning bid by changing or disabling one or both of the diversity constraint and predicted performance threshold (1230).

If the auction did result in a winning bid, auction system 208 may determine whether the position associated with the auction is the last position in the interface. If not, auction system 208 may move to the next position (1240) and conduct one or more auctions to determine a winning bid for the next position. In some implementations, varying predicted performance threshold values may be applied across the different positions, such as is described above with reference to processes 400 and 500. If the position associated with the last auction is the last position of the interface, the content interface may be generated based on the content items of the winning content bids (1245) and data representative of the content interface may be transmitted to the user device (1250).

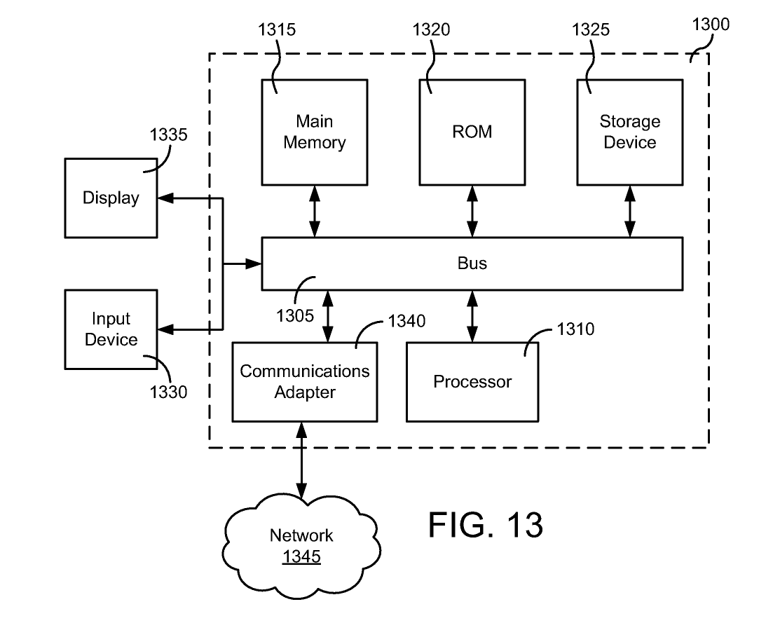

FIG. 13 illustrates a depiction of a computer system 1300 that can be used, for example, to implement an illustrative user device 204, an illustrative auction system 208, an illustrative content provider device 206, an illustrative content provider frontend 302, an illustrative auction system backend 304, an illustrative prediction system 306, an illustrative user interface system 310, an illustrative performance system 312, and/or various other illustrative systems that may be used in the implementation of an environment in which online content may be provided as described in the present disclosure. The computing system 1300 includes a bus 1305 or other communication component for communicating information and a processor 1310 coupled to the bus 1305 for processing information. The computing system 1300 also includes main memory 1315, such as a random access memory (RAM) or other dynamic storage device, coupled to the bus 1305 for storing information, and instructions to be executed by the processor 1310. Main memory 1315 can also be used for storing position information, temporary variables, or other intermediate information during execution of instructions by the processor 1310. The computing system 1300 may further include a read only memory (ROM) 1310 or other static storage device coupled to the bus 1305 for storing static information and instructions for the processor 1310. A storage device 1325, such as a solid state device, magnetic disk or optical disk, is coupled to the bus 1305 for persistently storing information and instructions.

The computing system 1300 may be coupled via the bus 1305 to a display 1335, such as a liquid crystal display, or active matrix display, for displaying information to a user. An input device 1330, such as a keyboard including alphanumeric and other keys, may be coupled to the bus 1305 for communicating information, and command selections to the processor 1310. In another implementation, the input device 1330 has a touch screen display 1335. The input device 1330 can include a cursor control, such as a mouse, a trackball, or cursor direction keys, for communicating direction information and command selections to the processor 1310 and for controlling cursor movement on the display 1335.

In some implementations, the computing system 1300 may include a communications adapter 1340, such as a networking adapter. Communications adapter 1340 may be coupled to bus 1305 and may be configured to enable communications with a computing or communications network 1345 and/or other computing systems. In various illustrative implementations, any type of networking configuration may be achieved using communications adapter 1340, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 1300 in response to the processor 1310 executing an arrangement of instructions contained in main memory 1315. Such instructions can be read into main memory 1315 from another computer-readable medium, such as the storage device 1325. Execution of the arrangement of instructions contained in main memory 1315 causes the computing system 1300 to perform the illustrative processes described herein. One or more processors in a multi-processing arrangement may also be employed to execute the instructions contained in main memory 1315. In alternative implementations, hard-wired circuitry may be used in place of or in combination with software instructions to implement illustrative implementations. Thus, implementations are not limited to any specific combination of hardware circuitry and software.

Although an example processing system has been described in FIG. 13, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
calculating, for each of a plurality of content bids, one or more performance characteristics associated with the content bid;
determining, using a computerized auction system, a first set of one or more eligible content bids from among the plurality of content bids by comparing the one or more performance characteristics of each of the plurality of content bids with a first set of one or more eligibility criteria, wherein the first set of one or more eligibility criteria comprises at least one first threshold value, wherein each of the plurality of content bids comprises a bid value and a content item associated with the content bid, wherein the first threshold value represents a first minimum performance measure for content items to be displayed within one or more first positions of a content interface, and wherein the content interface comprises a plurality of positions in which content items can be displayed;
conducting, using the auction system, a first auction process on the first set of one or more eligible content bids to determine one or more first content items to be displayed in the one or more first positions of the content interface;
determining, using the auction system, a second set of one or more eligible content bids from among the plurality of content bids by comparing the one or more performance characteristics of each of the plurality of content bids with a second set of one or more eligibility criteria, wherein the second set of one or more eligibility criteria comprises at least one second threshold value that is different from the at least one first threshold value, and wherein the second threshold value represents a second minimum performance measure for content items to be displayed within one or more second positions of the content interface;
conducting, using the auction system, a second auction process on the second set of one or more eligible content bids to determine one or more second content items to be displayed in the one or more second positions of the content interface;
generating, using the auction system, the content interface including the determined one or more first content items to be displayed and one or more second content items to be displayed; and
transmitting, using the auction system, data representative of the generated content interface to a computing device of a user.

2. The method of claim 1, further comprising:
receiving input from the computing device of the user; and
selecting the plurality of content bids to be evaluated for eligibility in the first auction process and the second auction process based on the input received from the computing device of the user.

3. The method of claim 1, wherein the at least one first threshold value comprises a first threshold predicted click through rate and the at least one second threshold value comprises a second threshold predicted click through rate that is different from the first threshold predicted click through rate.

4. The method of claim 1, wherein the at least one first threshold value comprises a first threshold utility score and the at least one second threshold value comprises a second threshold utility score that is different from the first threshold utility score, and wherein a utility score of a content bid is based on both the bid value of the content bid and a predicted click through rate for the content item associated with the content bid.

5. The method of claim 1, further comprising:
conducting a separate auction process for each position of the plurality of positions for the content interface to determine content items to be displayed in the plurality of positions; and
for each of the separate auction processes, applying a separate set of one or more eligibility criteria to determine eligible content items for the respective auction process from among the plurality of content items, wherein each of the separate sets of one or more eligibility criteria comprises at least one threshold value, and wherein the at least one threshold value of one set of one or more eligibility criteria is different from the at least one threshold value of another set of one or more eligibility criteria.

6. The method of claim 5, wherein the plurality of positions comprise a hierarchy of positions from a first position to a last position, and wherein the at least one threshold value associated with each position except the first position is lower than the at least one threshold value associated with the next highest position in the hierarchy.

7. The method of claim 5, further comprising, for each of the separate auction processes, determining the at least one threshold value based on a threshold function, wherein the threshold function defines a rate of change in the at least one threshold between the plurality of positions.

8. The method of claim 7, wherein the function comprises a linear function under which the at least one threshold decreases at a linear rate between adjacent positions.

9. The method of claim 7, wherein the function comprises an exponential function under which the at least one threshold decreases between adjacent positions at a rate defined by an exponential curve.

10. The method of claim 7, further comprising determining, for each of the separate auction processes, whether the at least one threshold value determined using the threshold function would fall below a minimum threshold value, wherein, when the at least one threshold value determined using the threshold function would fall below the minimum threshold value, setting the at least one threshold value to the minimum threshold value.

11. The method of claim 5, further comprising, for each of the separate auction processes, determining the at least one threshold value based on historical data, wherein the historical data is representative of an observed cost associated with adding a content item at a position within the plurality of positions as compared to leaving the position empty.

12. A system comprising:
at least one computing device operably coupled to at least one memory and configured to:
calculate, for each of a plurality of content bids, one or more performance characteristics associated with the content bid;
determine a first set of one or more eligible content bids from among the plurality of content bids by comparing the one or more performance characteristics of each of the plurality of content bids with a first set of one or more eligibility criteria, wherein the first set of one or more eligibility criteria comprises at least one first threshold value, wherein each of the plurality of content bids comprises a bid value and a content item associated with the content bid, wherein the first threshold value represents a first minimum performance measure for content items to be displayed within one or more first positions of a content interface, and wherein the content interface comprises a plurality of positions in which content items can be displayed;
conduct a first auction process on the first set of one or more eligible content bids to determine one or more first content items to be displayed in the one or more first positions of the content interface;
determine a second set of one or more eligible content bids from among the plurality of content bids by comparing the one or more performance characteristics of each of the plurality of content bids with a second set of one or more eligibility criteria, wherein the second set of one or more eligibility criteria comprises at least one second threshold value that is different from the at least one first threshold value, and wherein the second threshold value represents a second minimum performance measure for content items to be displayed within one or more second positions of the content interface;
conduct a second auction process on the second set of one or more eligible content bids to determine one or more second content items to be displayed in one or more second positions of the content interface;
generate the content interface including the determined one or more first content items to be displayed and one or more second content items to be displayed; and
transmit data representative of the generated content interface to a computing device of a user.

13. The system of claim 12, wherein the at least one first threshold value comprises a first threshold predicted click through rate and the at least one second threshold value comprises a second threshold predicted click through rate that is different from the first threshold predicted click through rate.

14. The system of claim 12, wherein the at least one first threshold value comprises a first threshold utility score and the at least one second threshold value comprises a second threshold utility score that is different from the first threshold utility score, and wherein a utility score of a content bid is based on both the bid value of the content bid and a predicted click through rate for the content item associated with the content bid.

15. The system of claim 12, wherein the at least one computing device is configured to:
conduct a separate auction process for each position of the plurality of positions for the content interface to determine content items to be displayed in the plurality of positions; and
for each of the separate auction processes, apply a separate set of one or more eligibility criteria to determine eligible content items for the respective auction process from among the plurality of content items, wherein each of the separate sets of one or more eligibility criteria comprises at least one threshold value, and wherein the at least one threshold value of one set of one or more eligibility criteria is different from the at least one threshold value of another set of one or more eligibility criteria.

16. The system of claim 15, wherein the plurality of positions comprise a hierarchy of positions from a first position to a last position, and wherein the at least one threshold value associated with each position except the first position is lower than the at least one threshold value associated with the next highest position in the hierarchy.

17. The system of claim 15, wherein the at least one computing device is configured to, for each of the separate auction processes, determine the at least one threshold value based on a threshold function, wherein the threshold function defines a rate of change in the at least one threshold between the plurality of positions.

18. The system of claim 17, wherein the function comprises one of a linear function under which the at least one threshold decreases at a linear rate between adjacent positions or an exponential function under which the at least one threshold decreases between adjacent positions at a rate defined by an exponential curve.

19. The method of claim 5, further comprising, for each of the separate auction processes, determining the at least one threshold value based on historical data, wherein the historical data is representative of an observed cost associated with adding a content item at a position within the plurality of positions as compared to leaving the position empty.

20. A computer-readable storage medium having instructions stored thereon that, when executed by a processor, cause the processor to perform operations comprising:
calculating, for each of a plurality of content bids, one or more performance characteristics associated with the content bid, wherein each of the plurality of content bids comprises a bid value and a content item associated with the content bid;
conducting a plurality of auction processes to determine content items to include within a content interface comprising a plurality of positions in which content items can be displayed, wherein conducting a plurality of auction processes comprises conducting a separate auction process for each position of the plurality of positions of the content interface, wherein conducting a plurality of auction processes further comprises, for each of the separate auction processes:
determining a set of one or more eligible content bids from among the plurality of content bids by comparing the one or more performance characteristics of each of the plurality of content bids with a set of one or more eligibility criteria for the auction process, wherein the set of one or more eligibility criteria for each auction process comprises at least one threshold value, wherein the at least one threshold value comprises a first minimum performance measure for content items to be displayed within the associated position of the content interface, and wherein the at least one threshold value for one of the separate auction processes is different from the at least one threshold value for at least one other of the separate auction processes; and
conducting the auction process on the set of one or more eligible content bids to determine a winning content item to be displayed in the associated position of the content interface;
generating the content interface including the winning content item from each of the separate auction processes; and
transmitting data representative of the generated content interface to a computing device of a user.

21. The computer-readable storage medium of claim 20, wherein the plurality of positions comprise a hierarchy of positions from a first position to a last position, and wherein the at least one threshold value associated with each position except the first position is lower than the at least one threshold value associated with the next highest position in the hierarchy.

22. The computer-readable storage medium of claim 20, wherein the operations further comprise, for each of the separate auction processes, determining the at least one threshold value based on a threshold function, wherein the threshold function defines a rate of change in the at least one threshold between the plurality of positions.

23. The computer-readable storage medium of claim 20, wherein the operations further comprise, for each of the separate auction processes, determining the at least one threshold value based on historical data, wherein the historical data is representative of an observed cost associated with adding a content item at a position within the plurality of positions as compared to leaving the position empty.
